(19) United States
(12) Patent Application Publication
(10) Pub. No.: US 2010/0191793 A1
(43) Pub. Date: Jul. 29, 2010

(54) Symbolic Computation Using Tree-Structured Mathematical Expressions

(75) Inventors: Xu Yang, Beijing (CN); Xiaolin Quan, Wuhan (CN); Dongmei Zhang, Redmond, WA (US); Gong Cheng, Beijing (CN); Jian Wang, Beijing (CN); Hao Wei, Beijing (CN)

Correspondence Address: MICROSOFT CORPORATION, ONE MICROSOFT WAY, REDMOND, WA, 98052, US

(73) Assignee: Microsoft Corporation, Redmond, WA (US)

(21) Appl. No.: 12/360,853

(22) Filed: Jan. 28, 2009

(51) Int. Cl. G06F 7/38; G06F 17/10

(52) U.S. Cl. 708/490

(57) ABSTRACT

A method for performing symbolic computations on a mathematical expression. The mathematical expression may be converted to a tree structure having one or more parent nodes and one or more child nodes. Each parent node may be a mathematical operation. Each child node may be a mathematical expression on which the mathematical operation is performed in a specified order. Each child node may be in a hierarchical relationship to one of the parent nodes. The parent nodes, the child nodes or both may be manipulated to perform a first symbolic computation on the mathematical expression.

### BACKGROUND

Symbolic computation refers to the transformation of mathematical expressions in symbolic form. Mathematical expressions may also be transformed in numeric form; however, numeric form is less precise than symbolic. Transforming mathematical expressions in symbolic form is more precise than numeric form, because the numeric form may be calculated in floating-point computation, which has limited precision. Typical operations in symbolic computation include differentiation and integration, linear algebra and matrix calculus, operations with polynomials, or the simplification of algebraic expressions.

Because of the resources required for symbolic computation, software may be used to perform symbolic computation. Software approaches range from programs designed specifically for symbolic computation to programming languages designed with special libraries for performing symbolic computation. Programs or systems in this area which provide a language interface are called Computer Algebra Systems (CASes).

CASes are typically designed for applications in theoretical physics or mathematics. These systems may be used for applications where straightforward, but tedious or lengthy calculations are required.

### SUMMARY

Described herein are implementations of various technologies for performing symbolic computations on a mathematical expression. The mathematical expression may be converted to a tree structure. The tree structure may contain parent nodes and child nodes. The parent nodes may be mathematical operations to be performed on the parent node's child nodes. Symbolic computations, such as a polynomial expand, may be performed using tree operations on the tree-structured mathematical expression. Tree operations may manipulate the position and/or content of the parent nodes and the child nodes, thereby resulting in changes to the mathematical expression represented by the modified tree structure.

The claimed subject matter is not limited to implementations that solve any or all of the noted disadvantages. Further, the summary section is provided to introduce a selection of concepts in a simplified form that are further described below in the detailed description section. The summary section is not intended to identify key features or essential features of the claimed subject matter, nor is it intended to be used to limit the scope of the claimed subject matter.

### BRIEF DESCRIPTION OF THE DRAWINGS

FIG. 1 illustrates a schematic diagram of a computing system in which various technologies described herein may be incorporated and practiced.

FIG. 2 illustrates a flow chart of a method for performing symbolic computations on a mathematical expression in accordance with various implementations of the technologies described herein.

FIG. 3 illustrates a tree structure that results from a SWAP CHILD tree operation on a tree structure in accordance with various implementations of the technologies described herein.

FIG. 4 illustrates a tree structure that results from an EXPAND CHILD tree operation on a tree structure in accordance with various implementations of the technologies described herein.

FIG. 5 illustrates a tree structure that results from a REPLACE CHILD tree operation on a tree structure in accordance with various implementations of the technologies described herein.

FIG. 6 illustrates a tree structure that results from a ROTATE tree operation on a tree structure in accordance with various implementations of the technologies described herein.

FIG. 7 illustrates a tree structure that results from an INSERT tree operation on a tree structure in accordance with various implementations of the technologies described herein.

FIG. 8 illustrates a tree structure that results from an ADD tree operation on a tree structure in accordance with various implementations of the technologies described herein.

FIG. 9 illustrates a tree structure that results from a REMOVE tree operation on a tree structure and in accordance with various implementations of the technologies described herein.

FIG. 10 illustrates tree structures in a sequence of tree operations performed for a polynomial expansion symbolic computation in accordance with various implementations of the technologies described herein.

### DETAILED DESCRIPTION

In general, one or more implementations of various technologies described herein are directed performing symbolic computations on a mathematical expression. The various implementations will be described in more detail in the following paragraphs.

Implementations of various technologies described herein may be operational with numerous general purpose or special purpose computing system environments or configurations. Examples of well known computing systems, environments, and/or configurations that may be suitable for use with the various technologies described herein include, but are not limited to, personal computers, server computers, hand-held or laptop devices, multiprocessor systems, microprocessor-based systems, set top boxes, programmable consumer electronics, network PCs, minicomputers, mainframe computers, distributed computing environments that include any of the above systems or devices, and the like.

The various technologies described herein may be implemented in the general context of computer-executable instructions, such as program modules, being executed by a computer. Generally, program modules include routines, programs, objects, components, data structures, etc. that perform particular tasks or implement particular abstract data types. The various technologies described herein may also be implemented in distributed computing environments where tasks are performed by remote processing devices that are linked through a communications network, e.g., by hardwired links, wireless links, or combinations thereof. In a distributed computing environment, program modules may be located in both local and remote computer storage media including memory storage devices.

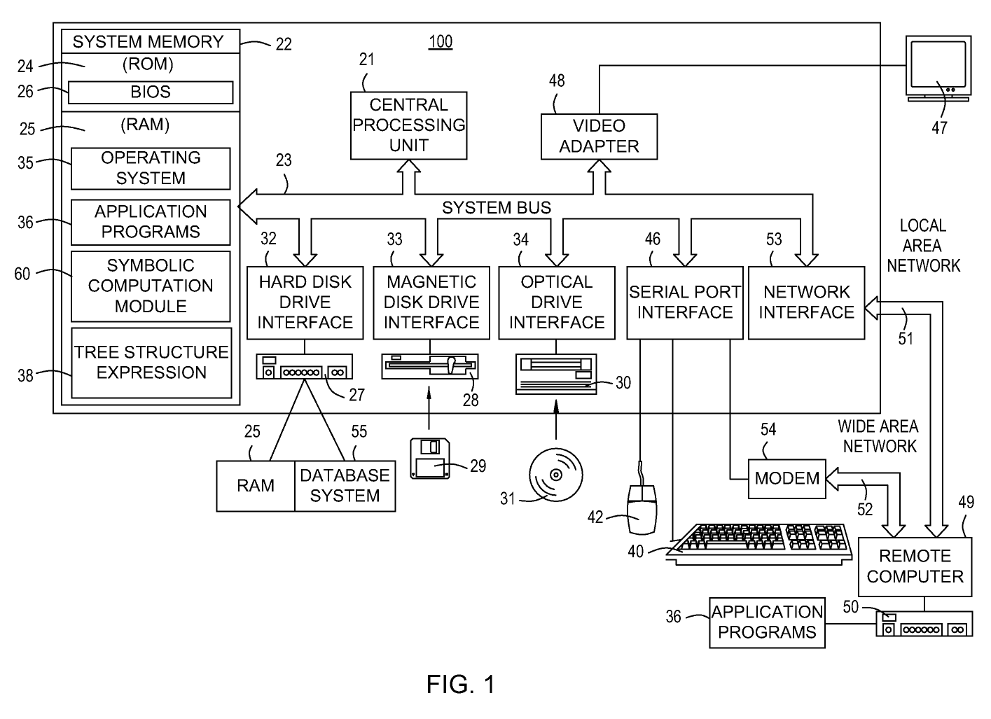

FIG. 1 illustrates a schematic diagram of a computing system 100 in which the various technologies described herein may be incorporated and practiced. Although the computing system 100 may be a conventional desktop or a server computer, as described above, other computer system configurations may be used.

The computing system 100 may include a central processing unit (CPU) 21, a system memory 22 and a system bus 23 that couples various system components including the system memory 22 to the CPU 21. Although only one CPU is illustrated in FIG. 1, it should be understood that in some implementations the computing system 100 may include more than one CPU. The system bus 23 may be any of several types of bus structures, including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus. The system memory 22 may include a read only memory (ROM) 24 and a random access memory (RAM) 25. A basic input/output system (BIOS) 26, containing the basic routines that help transfer information between elements within the computing system 100, such as during start-up, may be stored in the ROM 24.

The computing system 100 may further include a hard disk drive 27 for reading from and writing to a hard disk, a magnetic disk drive 28 for reading from and writing to a removable magnetic disk 29, and an optical disk drive 30 for reading from and writing to a removable optical disk 31, such as a CD ROM or other optical media. The hard disk drive 27, the magnetic disk drive 28, and the optical disk drive 30 may be connected to the system bus 23 by a hard disk drive interface 32, a magnetic disk drive interface 33, and an optical drive interface 34, respectively. The drives and their associated computer-readable media may provide nonvolatile storage of computer-readable instructions, data structures, program modules and other data for the computing system 100.

Although the computing system 100 is described herein as having a hard disk, a removable magnetic disk 29 and a removable optical disk 31, it should be appreciated by those skilled in the art that the computing system 100 may also include other types of computer-readable media that may be accessed by a computer. For example, such computer-readable media may include computer storage media and communication media.

Computer storage media may include volatile and non-volatile, and removable and non-removable media implemented in any method or technology for storage of information, such as computer-readable instructions, data structures, program modules or other data. Computer storage media may further include RAM, ROM, erasable programmable read-only memory (EPROM), electrically erasable programmable read-only memory (EEPROM), flash memory or other solid state memory technology, CD-ROM, digital versatile disks (DVD), or other optical storage, magnetic cassettes, magnetic tape, magnetic disk storage or other magnetic storage devices, or any other medium which can be used to store the desired information and which can be accessed by the computing system 100.

Communication media may embody computer readable instructions, data structures, program modules or other data in a modulated data signal, such as a carrier wave or other transport mechanism and may include any information delivery media. The term “modulated data signal” may mean a signal that has one or more of its characteristics set or changed in such a manner as to encode information in the signal. By way of example, and not limitation, communication media may include wired media such as a wired network or direct-wired connection, and wireless media such as acoustic, RF, infrared and other wireless media. Combinations of the any of the above may also be included within the scope of computer readable media.

A number of modules may be stored on the hard disk, magnetic disk 29, optical disk 31, ROM 24 or RAM 25, including an operating system 35, one or more application programs 36, a symbolic computation module 60, a tree structure equation 38, and a database system 55. The operating system 35 may be any suitable operating system that may control the operation of a networked personal or server computer, such as Windows® XP, Mac OS® X, Unix-variants (e.g., Linux® and BSD®), and the like.

The tree structure equation 38 may include a mathematical expression that is represented in a tree-like structure. Specifically, the tree structure equation 38 may include parent nodes and child nodes that contain mathematical operations and mathematical expressions of the mathematical expression, respectively.

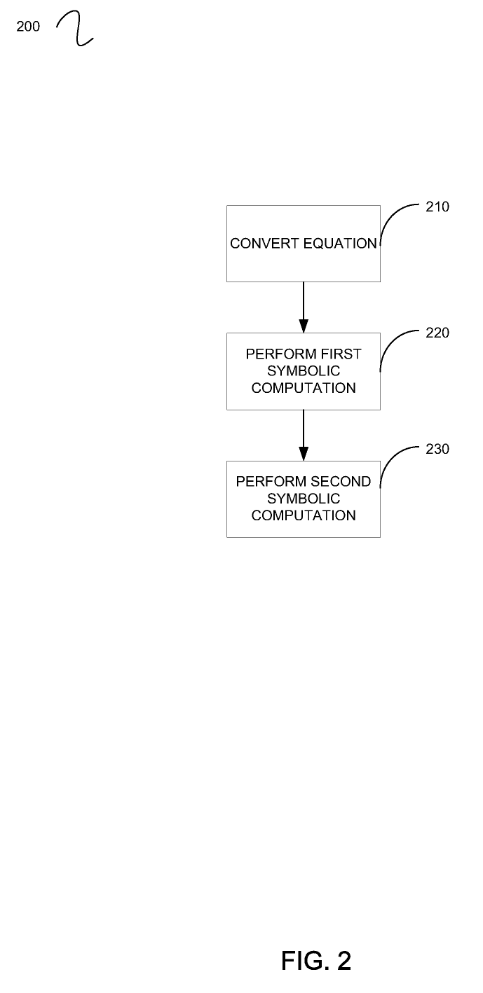

The symbolic computation module 60 may convert a mathematical expression to the tree structure equation 38. Further, the symbolic computation module 60 may perform symbolic computations on the mathematical expression by performing tree operations on the tree structured equation 38. The symbolic computation module 60 and the tree structured equation 38 will be described in more detail with reference to FIGS. 2-10 in the paragraphs below.

A user may enter commands and information into the computing system 100 through input devices such as a keyboard 40 and pointing device 42. Other input devices may include a microphone, joystick, game pad, satellite dish, scanner, or the like. These and other input devices may be connected to the CPU 21 through a serial port interface 46 coupled to system bus 23, but may be connected by other interfaces, such as a parallel port, game port or a universal serial bus (USB). A monitor 47 or other type of display device may also be connected to system bus 23 via an interface, such as a video adapter 48. In addition to the monitor 47, the computing system 100 may further include other peripheral output devices, such as speakers and printers.

Further, the computing system 100 may operate in a networked environment using logical connections to one or more remote computers, such as a remote computer 49. The remote computer 49 may be another personal computer, a server, a router, a network PC, a peer device or other common network node. Although the remote computer 49 is illustrated as having only a memory storage device 50, the remote computer 49 may include many or all of the elements described above relative to the computing system 100. The logical connections may be any connection that is commonplace in offices, enterprise-wide computer networks, intranets, and the Internet, such as local area network (LAN) 51 and a wide area network (WAN) 52.

When using a LAN networking environment, the computing system 100 may be connected to the local network 51 through a network interface or adapter 53. When used in a WAN networking environment, the computing system 100 may include a modem 54, wireless router or other means for establishing communication over a wide area network 52, such as the Internet. The modem 54, which may be internal or external, may be connected to the system bus 23 via the serial port interface 46. In a networked environment, program modules depicted relative to the computing system 100, or portions thereof, may be stored in a remote memory storage device 50. It will be appreciated that the network connections shown are exemplary and other means of establishing a communications link between the computers may be used.

It should be understood that the various technologies described herein may be implemented in connection with hardware, software or a combination of both. Thus, various technologies, or certain aspects or portions thereof, may take the form of program code (i.e., instructions) embodied in tangible media, such as floppy diskettes, CD-ROMs, hard drives, or any other machine-readable storage medium wherein, when the program code is loaded into and executed by a machine, such as a computer, the machine becomes an apparatus for practicing the various technologies. In the case of program code execution on programmable computers, the computing device may include a processor, a storage medium readable by the processor (including volatile and non-volatile memory and/or storage elements), at least one input device, and at least one output device.

One or more programs that may implement or utilize the various technologies described herein may use an application programming interface (API), reusable controls, and the like. Such programs may be implemented in a high level procedural or object oriented programming language to communicate with a computer system. However, the program(s) may be implemented in assembly or machine language, if desired. In any case, the language may be a compiled or interpreted language, and combined with hardware implementations.

FIG. 2 illustrates a flow chart of a method 200 for performing symbolic computations on a mathematical expression in accordance with various implementations of the technologies described herein. The method 200 may be performed by the symbolic computation module 60.

At step 210, the symbolic computation module 60 may convert a mathematical expression to a tree structure equation 38. As stated previously, the tree structure equation 38 may include child nodes and parent nodes that represent mathematical expressions and mathematical operations, respectively. Each child node may be in a hierarchical relationship with one parent node.

The mathematical operation of the parent node may be performed on the child nodes for the parent node in a specified order. The specified order may be represented in the sequence of the child nodes that contain the mathematical expressions.

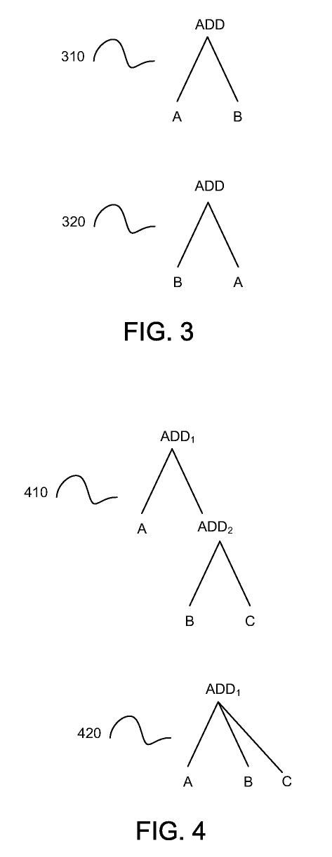

For example, FIG. 3 illustrates a tree structure 310 that includes the child nodes with the mathematical expressions, “A” and “B,” and a parent node, “ADD.” As stated previously, the operation of the parent node, “ADD,” is performed on the mathematical expressions of the child nodes, “A” and “B.” Further, the operation may be performed in the specified order represented in the sequence of the mathematical expressions in the tree, i.e. “A,” followed by “B.” As such, the tree structure 310 may represent the mathematical expression, “A+B.”

At step 220, the symbolic computation module 60 may perform a first symbolic computation on the mathematical expression. The symbolic computation may be performed by manipulating the parent nodes, child nodes or both in the tree structure equation 38.

Tree operations may be used to manipulate the parent nodes and the child nodes. The tree operations are referred to herein individually as, SWAP CHILD, EXPAND CHILD, REPLACE CHILD, ROTATE, INSERT, ADD, and REMOVE, each of which will be described with reference to FIGS. 3-9 below.

Symbolic computations may be described in levels of complexity: low and high. Symbolic computations with a low level of complexity may be performed by using one or more of the tree operations. The low level symbolic computations may include operations, such as, a polynomial expansion operation, a rational together operation, an apart operation, or a partial fraction operation.

One example of a polynomial expansion operation is the expansion of a product of sums. In a polynomial expansion of a product of sums, the product of sums is expressed as a sum of products by using the fact that multiplication distributes over addition. Expansions of polynomials are obtained by multiplying together their factors, which results in a sum of terms with variables raised to different degrees. For example, a polynomial expansion of the mathematical expression:

X*(A+B)

results in:

(X*A)+(X*B)

The rational together operation may put terms in a sum over a common denominator. For example, a rational together of:

(A/B)+D

results in:

(A+DB)/B

The rational together operation may also cancel common factors in the numerator and denominator of the result.

The apart operation may distribute the fraction parts according to a sum symbol. No operations will be executed. The following is an example of the apart operation:

$$\frac{{( x + 1 )}^{2} sin ( x )}{x} ⇒ \frac{{( x + 1 )}^{2}}{x} + \frac{sin ( x )}{x}$$

The partial fraction operation may include a partial fraction decomposition or a partial fraction expansion. The partial fraction operation may reduce the degree of either the numerator or the denominator of a rational function. The outcome of partial fraction expansion expresses that function as a sum of fractions, where the denominator of each term is a power of an irreducible (not factorable) polynomial, and the numerator is a polynomial of smaller degree than that irreducible polynomial. The following is an example of the partial fraction expansion:

$$\frac{{( x + 1 )}^{2} sin ( x )}{x} ⇒ x + 2 + \frac{1}{x} + \frac{sin ( x )}{x}$$

At step 230, the symbolic computation module 60 may perform a second symbolic computation on the mathematical expression. As stated previously, the symbolic computations may include both low and high level computations. The second symbolic computation may be one of the high level symbolic computations.

The high level symbolic computations may be performed through the use of one or more low level symbolic computations, i.e., the first symbolic computation. The high level symbolic computations may include operations, such as, a factorization operation, a greatest common divisor operation, or a resultant computation operation.

In mathematics, factorization or factoring is the decomposition of an object (for example, a number, a polynomial, or a matrix) into a product of other objects, or factors, which when multiplied together give the original. For example, the number 15 factors into primes as 3×5, and the polynomial x²−4 factors as (x−2)*(x+2). In all cases, a product of simpler objects is obtained.

In mathematics, the greatest common divisor operation (GCD), sometimes known as the greatest common factor (GCF) or highest common factor (HCF), of two non-zero integers, is the largest positive integer that divides both numbers without remainder. This notion can be extended to polynomials.

In mathematics, the resultant of two monic polynomials P and Q over a field k is defined as the product of the differences of their roots, where x and y take on values in the algebraic closure of k.

$$res ( P , Q ) = {\prod }_{( x , y ) : P ( x ) = 0 , Q ( y ) = 0} ( x - y ) .$$

For non-monic polynomials with leading coefficients p and q, respectively, the above product is multiplied by:

P^{degree of Q}(Q^{degree of P})

FIG. 3 illustrates a tree structure 320 that results from a SWAP CHILD tree operation on a tree structure 310 in accordance with various implementations of the technologies described herein. The SWAP CHILD tree operation may be performed by the symbolic computation module 60.

The tree structure 310 may represent the following equation:

A+B

The SWAP CHILD operation may swap the specified order in which the mathematical operation is performed on two of the child nodes. In this example, the “A” and “B” child nodes may be swapped. Accordingly, the tree structure 320 represents a new equation with the specified order changed after the swap:

B+A

FIG. 4 illustrates a tree structure 420 that results from an EXPAND CHILD tree operation on a tree structure 410 in accordance with various implementations of the technologies described herein. The EXPAND CHILD tree operation may be performed by the symbolic computation module 60. The EXPAND CHILD tree operation may replace a parent node with the child nodes in the hierarchical relationship with the parent node, i.e., the child nodes of the replaced parent node.

For example, the tree structure 410 may represent the following equation:

A+(B+C)

It should be noted that the subscripts, 1 and 2 on the add operations are provided merely for the purpose of identification, and do not indicate a difference between the two addition operations. An EXPAND CHILD operation on the parent node, “ADD₂,” may replace the parent node having the “ADD₂” operation with the parent node's two child nodes, “A” and “B.” As such, the tree structure 420 may result that represents the following equation:

A+B+C

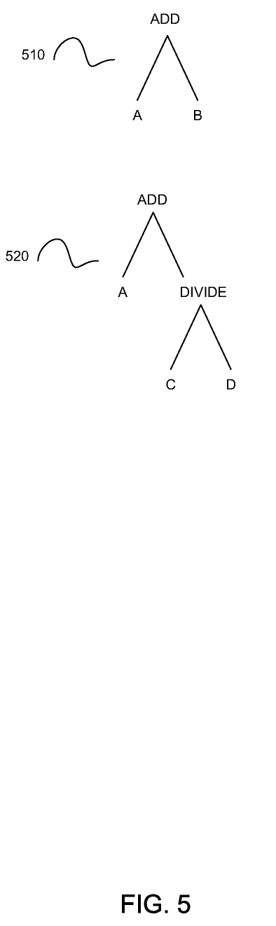

FIG. 5 illustrates a tree structure 520 that results from a REPLACE CHILD tree operation on a tree structure 510 in accordance with various implementations of the technologies described herein. The REPLACE CHILD tree operation may be performed by the symbolic computation module 60. The REPLACE CHILD tree operation may replace one of the child nodes with a replacement mathematical expression.

For example, the tree structure 510 may represent the equation:

A+B

If the REPLACE CHILD tree operation were to replace the child node labeled, “B” with a mathematical expression, such as:

C/D,

The tree structure 520 may result, which represents the equation:

A+C/D

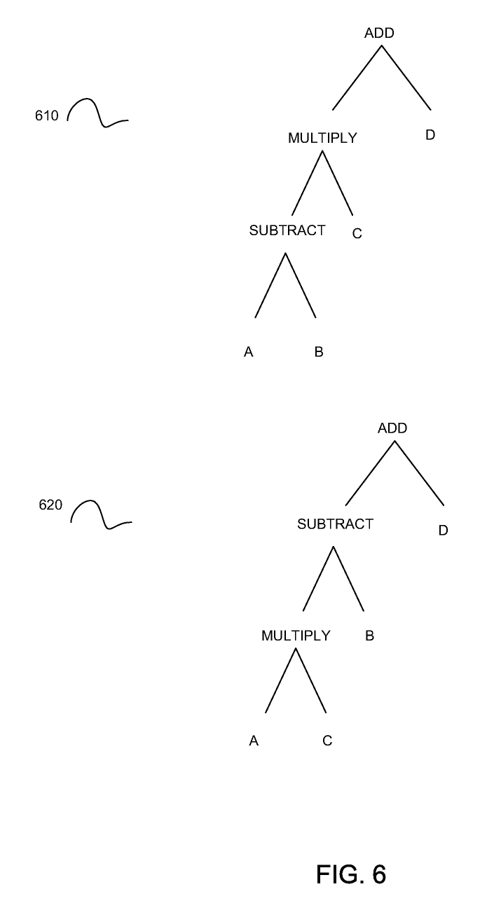

FIG. 6 illustrates a tree structure 620 that results from a ROTATE tree operation on a tree structure 610 in accordance with various implementations of the technologies described herein. The ROTATE tree operation may be performed by the symbolic computation module 60.

The ROTATE tree operation may swap positions in the tree structure 610 for a parent node, and the parent node's parent node (grandparent node). Further, a child node of the parent node may be selected based on a right or left direction from the parent node to the grandparent node. If the grandparent is to the right of the parent node, the left child may be selected; otherwise, the right child may be selected. The selected child node may then be moved to become a child node of the grandparent node

For example, the tree structure 610 represents the equation:

[(A−B)*C]+D

A rotate on the parent node labeled, “SUBTRACT,” may be performed as follows. The parent node labeled, “SUBTRACT,” may switch positions with “SUBTRACT's” parent node, labeled, “MULTIPLY.”

Then, one of the child nodes of the parent node, “SUBTRACT,” may be selected based on a direction from the parent node, “SUBTRACT,” to the grandparent node, “MULTIPLY.” Because the grandparent node is to the right of the parent node, the left child node of the parent node, labeled, “A,” may be moved to the grandparent node.

The resulting tree structure 620 may represent the following equation:

[(A*C)−B]+D

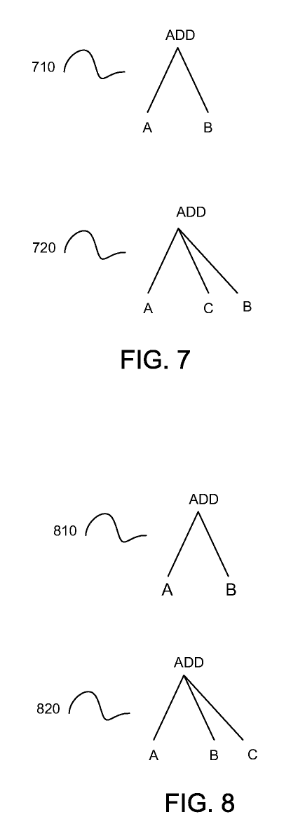

FIG. 7 illustrates a tree structure 720 that results from an INSERT tree operation on a tree structure 710 in accordance with various implementations of the technologies described herein. The INSERT tree operation may be performed by the symbolic computation module 60.

The INSERT tree operation may add a new child node to one of the parent nodes. Further, the point of insertion may be specified, thereby modifying the specified order that the mathematical operation is performed. Specifically, the newly inserted child node may be performed before at least one of the other child nodes of the parent node to which the new child node is added.

For example, the tree structure 710 may represent the following equation:

A+B

A new child node labeled, “C,” may be inserted before the child node labeled, “B.” The INSERT results in the tree structure 720, which may represent the following equation:

A+C+B

FIG. 8 illustrates a tree structure 820 that results from an ADD tree operation on a tree structure 810 in accordance with various implementations of the technologies described herein. The ADD tree operation may be performed by the symbolic computation module 60. The ADD tree operation may be similar to the INSERT tree operation with one exception. The specified order may be modified such that the mathematical operation is performed on the new child node last.

For example, the tree structure 810 may represent the equation:

A+B

If a new child node labeled, “C,” is added to the parent node labeled, “ADD,” the tree structure 820 may result. The tree structure 820 may represent the equation:

A+B+C

Note that the new child node is positioned last in the sequence of the child nodes. The sequence represented may indicate that the specified order of the ADD operation is performed on the new child node last.

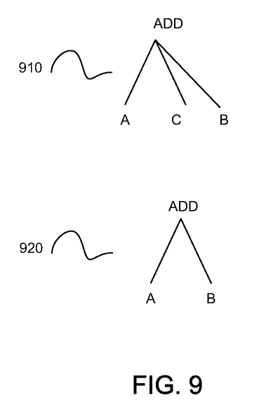

FIG. 9 illustrates a tree structure 920 that results from a REMOVE tree operation on a tree structure 910 and in accordance with various implementations of the technologies described herein. The REMOVE tree operation may be performed by the symbolic computation module 60. The REMOVE tree operation may remove a child node from the tree structure.

For example, the tree structure 910 may represent the following equation:

A+C+B

A REMOVE tree operation may be performed on the child node labeled, “C,” giving the tree structure 920, which may represent the following equation:

A+B

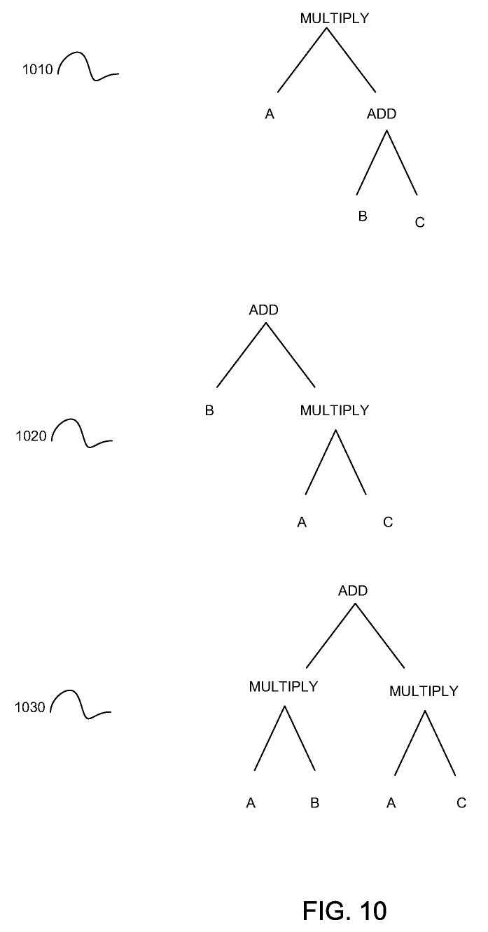

FIG. 10 illustrates tree structures 1010, 1020, and 1030 in a sequence of tree operations performed for a polynomial expansion symbolic computation in accordance with various implementations of the technologies described herein. The symbolic computation module 60 may perform the polynomial expansion.

As shown, the tree structure 1010 may represent the following equation:

A*(B+C)

A polynomial expansion may produce the following equation:

(A*B)+(A*C)

In one implementation, a ROTATE tree operation may be performed on the tree structure 1010, giving the tree structure 1020. A REPLACE tree operation may then be performed, replacing the child node labeled, “B,” with the mathematical expression, “A*B,” giving the tree structure 1030. The tree structure 1030 may represent the following equation:

(A*B)+(A*C),

which is the result of the polynomial expansion as described above. The combination of the ROTATE and REPLACEMENT tree operations may be used to perform the other symbolic computations described above. The polynomial expansion operation is used merely as an example and is not intended to limit implementations of various technologies described herein.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A method for performing symbolic computations on a mathematical expression, comprising:
converting the mathematical expression to a tree structure having one or more parent nodes and one or more child nodes, each parent node being a mathematical operation and each child node being a second mathematical expression on which the mathematical operation is performed in a specified order, each child node being in a hierarchical relationship to one of the parent nodes; and
manipulating the parent nodes, the child nodes or both to perform a first symbolic computation on the mathematical expression.

2. The method of claim 1, wherein each child node has an index number that indicates the specified order.

3. The method of claim 1, wherein manipulating the parent nodes, the child nodes or both comprises swapping the specified order in which the mathematical operation is performed on two of the child nodes.

4. The method of claim 1, wherein manipulating the parent nodes, the child nodes or both comprises:
adding a new child node to the one of the parent nodes; and
modifying the specified order such that the mathematical operation is performed on the new child node before a child node of the one of the parent nodes.

5. The method of claim 1, wherein manipulating the parent nodes, the child nodes or both comprises replacing the one of the parent nodes with the child nodes being in the hierarchical relationship with the one of the parent nodes.

6. The method of claim 1, wherein manipulating the parent nodes, the child nodes or both comprises replacing one of the child nodes with a replacement mathematical expression.

7. The method of claim 1, wherein manipulating the parent nodes, the child nodes or both comprises:
swapping the one of the parent nodes with a parent node of the one of the parent nodes;
selecting a child node of the one of the parent nodes based on a right or left direction from the one of the parent nodes to the parent node of the one of the parent nodes; and
moving the selected child node of the one of the parent nodes to become a child node of the parent node of the one of the parent nodes.

8. The method of claim 1, wherein manipulating the parent nodes, the child nodes or both comprises removing one of the child nodes from the tree structure.

9. The method of claim 1, wherein manipulating the parent nodes, the child nodes or both comprises:
adding a new child node to the one of the parent nodes; and
modifying the specified order such that the mathematical operation is performed on the new child node last.

10. The method of claim 1, wherein the first symbolic computation is one of:
a polynomial expansion operation;
a rational together operation;
an apart operation; and
a partial fraction operation.

11. The method of claim 1, further comprising performing a second symbolic computation using the first symbolic computation.

12. The method of claim 11, wherein the second symbolic computation is one of:
a resultant computation operation;
a factorization operation; and
a greatest common divisor operation.

13. The method of claim 1, wherein one of the child nodes comprises a parent node having one or more of the child nodes.

14. A computer-readable medium comprising instructions executable by a processor to cause a computer to:
convert a mathematical expression to a tree structure having one or more parent nodes and one or more child nodes, each parent node being a mathematical operation and each child node being a second mathematical expression on which the mathematical operation is performed in a specified order, each child node being in a hierarchical relationship to one of the parent nodes; and
manipulate the parent nodes, the child nodes or both to perform a first symbolic computation on the mathematical expression; and
perform a second symbolic computation using the first symbolic computation.

15. The computer-readable medium of claim 14, wherein each child node has an index number that indicates the specified order.

16. A system, comprising:
a processor; and
a memory comprising computer-executable instructions executable by the processor to:
convert a mathematical expression to a tree structure having one or more parent nodes and one or more child nodes, each parent node being a mathematical operation, each child node being a second mathematical expression on which the mathematical operation is performed in a specified order, each child node being in a hierarchical relationship to one of the parent nodes, and one of the child nodes comprises a parent node having one or more of the child nodes; and
perform a first symbolic computation on the mathematical expression by:
swapping the one of the parent nodes with a parent node of the one of the parent nodes;
selecting a child node of the one of the parent nodes based on a right or left direction from the one of the parent nodes to the parent node of the one of the parent nodes;
moving the selected child node of the one of the parent nodes to become a child node of the parent node of the one of the parent nodes; and
replacing one of the child nodes with a replacement mathematical expression.

17. The system of claim 16, wherein the first symbolic computation is a polynomial expansion operation.

18. The system of claim 16, wherein the first symbolic computation is an apart operation.

19. The system of claim 16, further comprising performing a second symbolic computation using the first symbolic computation.

20. The system of claim 19, wherein the second symbolic computation is one of:
a resultant computation operation;
a factorization operation; and
a greatest common divisor operation.
